(19) United States
(12) Patent Application Publication
(10) Pub. No.: US 2012/0270978 A1
(43) Pub. Date: Oct. 25, 2012

(54) PLASTICIZED POLYLACTIDE

(75) Inventors: Sasha B. Myers, Arden Hills, MN (US); Jay M. Jennen, Forest Lake, MN (US); Ronald W. Ausen, Saint Paul, MN (US); Terence D. Spawn, Stillwater, MN (US); Kelly S. Anderson, Houlton, WI (US); John W. Frank, Cottage Grove, MN (US)

(73) Assignee: 3M Innovative Properties Company

(21) Appl. No.: 13/518,123

(22) PCT Filed: Dec. 22, 2010
(86) PCT No.: PCT/US10/61737

§ 371 Date: Jun. 21, 2012

Related U.S. Application Data
(60) Provisional application No. 61/290,356, filed on Dec. 28, 2009.

(51) Int. Cl. C08K 5/10; B29C 47/88; C08L 67/04

(52) U.S. Cl. 524/310; 524/311; 264/177.19

(57) ABSTRACT

A composition that includes polylactide resin and plasticizer, the plasticizer having a chemical formula: wherein R may be the same or different and wherein at least one R is a branched alkyl group having a carbon chain length of C₅ or greater; and R is an H or an acyl group. In another aspect, the invention provides a process for providing an semicrystalline polylactide film, the process including the steps of providing a polylactide composition that includes polylactide resin, nucleating agent, and the foregoing plasticizer. The composition is extruded as a molten sheet which is then cooled to crystallize the polylactide and provide the film.

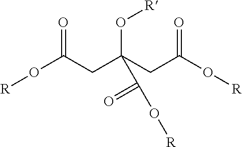

The present invention relates to compositions, films, processes for the manufacture of such films and final articles, all of which include polylactide along with at least one plasticizer.

### BACKGROUND

Renewable polymers are derived from natural or biomass materials. Renewable, degradable polymers are of interest when addressing issues presented by the use of petroleum-based polymers such as waste management, availability, and cost. There is a long-felt need for improved and renewable polymer films suitable for use in any of a variety of products.

A commercially available, renewable polymer is that produced from the polymerization of lactic acid or lactide. Lactic acid is obtained by the bacterial fermentation of corn starch or cane sugar. But, lactic acid cannot be directly polymerized to a useful product because the polymerization reaction generates water, the presence of which degrades the formation of the polymer chain and results in a low molecular weight polymer. To avoid this problem, lactic acid is typically converted to the cyclic lactide monomer which is more readily polymerized into polymers having a wide range of molecular weights. The resulting polymer material is typically referred to as “polylactic acid,” “polylactide” or “PLA.”

By itself, PLA can be difficult to use as a replacement for some widely used petroleum-based polymers such as polypropylene (PP) and polyethylene (PE). Both polypropylene and polyethylene have glass transition temperatures (T_{g}) (e.g., about −80° C.) that are much lower than the T_{g} for PLA (about 60° C.). Although their crystal melting points are similar (within 130° C.-160° C.), PLA's crystallization rate is slower than that of PE or PP. Consequently, producing a flexible, semi-crystalline PLA film can be more difficult than creating a similar film from PP or PE.

To obtain a softer, flexible PLA film, it is common to formulate a film-forming composition that includes PLA as well as a plasticizer that is miscible with the PLA. The use of a plasticizer effectively lowers the glass transition temperature (T_{g}) of the PLA, even at low levels of plasticizer. One commonly used plasticizer for PLA is acetyl tri(n-butyl) citrate which, when compounded with PLA at levels of about 15 wt %, provides a PLA film with a lowered glass transition temperature (e.g., T_{g}=about 30° C.). The plasticized film is initially softer than a non-plasticized film and the lowered T_{g} enables crystallization during processing. However, these improved properties can diminish over time as the plasticizer “blooms” to the film's surface and evaporates. These effects can be noticed at room temperature and can become more pronounced at elevated temperatures (e.g., 40° C. and higher).

### SUMMARY

There is a need for compositions that include PLA and at least one plasticizer, for age-stable films and articles made from such compositions and for methods for the manufacture of such age-stable films and articles.

The present invention addresses the foregoing unmet needs of the art by providing, in one aspect, a composition, comprising:

Polylactide resin; and

Plasticizer of the formula

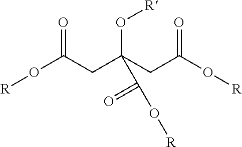

wherein
R may be the same or different and wherein at least one R is a branched alkyl group having a carbon chain length of C₅ or greater; and
R′ is an H or an acyl group.

In another aspect, the invention provides a process for providing an semicrystalline polylactide film, the process comprising:

(a) Providing a polylactide composition as comprising:
(i) Polylactide resin,
(ii) Nucleating agent, and
(iii) Plasticizer of the formula

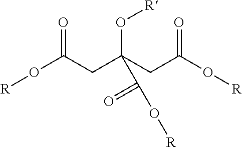

wherein
   R may be the same or different and wherein at least one R group is a branched alkyl groups having a carbon chain length of C₅ or greater, and
   R′ is H or an acyl group; and

(b) Extruding the composition as a molten sheet; and

(c) Cooling the sheet to crystallize the polylactide and provide the film.

The term “age-stable” as applied to a material, refers to an assessment of a material's change in properties over time. In some instances, age stability is measured by determining changes in the material's weight or mass over time. In some instances, age stability is measured by a determination of changes in the mechanical properties of the material over time. Age stability may be assessed after the material is exposed to elevated temperatures. Even in cases where significant weight loss doe not occur, erosion of a material's mechanical properties provides an indication of poor age stability.

The terms “polylactide,” “PLA” and “polylactic acid” are used interchangeably and refer to the same polymeric material.

The terms “comprises” and variations thereof do not have a limiting meaning where these terms appear in the description and claims.

As used herein, “a,” “an,” “the,” “at least one,” and “one or more” are used interchangeably. Thus, for example, a composition comprising “a” nucleating agent can be interpreted to mean that the composition includes “one or more” nucleating agents. Similarly, a composition comprising “a” plasticizer can be interpreted to mean that the composition includes “one or more” plasticizers.

As used herein, the term “or” is generally employed in its sense including “and/or” unless the content clearly dictates otherwise. The term “and/or” means one or all of the listed elements or a combination of any two or more of the listed elements.

As used herein, all numerical values are assumed to be modified by the term “about.”

It will be understood that any recitation herein of numerical ranges by endpoints include all numbers subsumed within the recited range (e.g., 1 to 5 includes 1, 1.5, 2, 2.75, 3, 3.80, 4, 5, etc.). Also, a numerical range that includes “up to” a certain value will be understood to include that value.

The foregoing summary is not intended to describe every possible embodiment or implementation of the present invention. Those of ordinary skill in the art will gain an understanding of the invention upon review of the remaining sections herein, including the Detailed Description, the non-limiting Examples and the appended claims.

### DETAILED DESCRIPTION

In the various embodiments of the invention, compositions are described comprising polylactide (or PLA) and at least one plasticizer. Films and articles made from the foregoing compositions and methods for the manufacture of such films and articles are also described. In embodiments of the invention, certain plasticizers are incorporated into the compositions, articles and films in order to provide soft, age-stable PLA film.

Polylactide (PLA) is a renewable polymeric material. Lactic acid has two optical isomers, L-lactic acid, also known as (S)-lactic acid, and D-lactic acid, also known as (R)-lactic acid. Due to the chiral nature of lactic acid, several distinct forms of polylactide exist: L,L-lactide, also known as L-lactide, which comprises two (S)-lactic acid residuals; D,D-lactide, also known as D-lactide, which comprises two (R)-lactic acid residuals; and meso-lactide, which comprises one each of (R)- and (S)-lactic acid residuals. Polymerization of a racemic mixture of L- and D-lactides usually leads to the synthesis of poly-DL-lactide, an amorphous material. The resulting crystallinity of PLA films is often enhanced by the use of nucleating agents, and plasticizers are added to enhance flexibility, durability and the overall ‘feel’ of the film.

Plasticizer molecules are thought to embed themselves between the chains of polymers, spacing the polymer molecules apart (e.g., increasing the “free volume”), and thus lowering the glass transition temperature for the plastic while making it softer. For plastic materials, the more plasticizer, the lower the plastic's glass transition temperature (T_{g}). Traditional plasticizers for PLA films and articles have tended to migrate from within the polymer to the outer surface, a phenomenon known as “blooming.”. Once at the surface, some plasticizer molecules are volatile enough to evaporate into the surrounding atmosphere at a rate dependent, in part, on the surrounding temperature. With the “blooming” of some plasticizers, PLA films can experience a decrease in their initial flexibility, and can become increasingly oily and slippery to the touch. Additionally, properties such as tensile strength, modulus, tear strength and elongation to break can be adversely effected and tends to justify the characterization of such films as exhibiting poor age stability.

In embodiments of the invention, a molten PLA composition is provided for use in making a tough, age-stable film. The composition includes PLA resin together with a plasticizer and, typically, a nucleating agent. PLA may be obtained from commercial sources such as Natureworks LLC, Minnetonka, Minn.

In the embodiments herein, plasticizers suitable for inclusion in the PLA compositions are those comprising branched alkyl groups, and the plasticizer is represented by the following Formula (I):

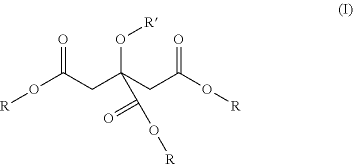

wherein
R may be the same or different and wherein at least one of the three ‘R’ groups are branched alkyl groups having a carbon chain length of C₅ or greater; and
R′ is an H or an acyl group.

In some embodiments, a PLA composition includes plasticizer according to Formula (I) wherein R is one or more branched alkyl groups having a carbon chain length of C₅ to C₁₀, or C₅ to C₈, for example, and wherein R′ is acetyl.

In some embodiments, the plasticizer is as shown in Formula (I) and at least one R group is a branched C₅ alkyl and R′ is H or acetyl. In some embodiments where one or more R groups are branched C₅ alkyl groups, the C₅ alkyl groups can be 3-methylbutyl. In a specific embodiment, all of the R groups are 3-methylbutyl and R′ is acetyl—i.e. the plasticizer is acetyl tris-3-methylbutyl citrate.

In some embodiments, the plasticizer is as shown in Formula (I) and at least one R group is a branched C₅ alkyl and R′ is H or acetyl. In some embodiments where one or more R groups are branched C₅ alkyl groups, the C₅ alkyl groups are 2-methylbutyl. In a specific embodiment, all of the R groups are 2-methylbutyl and R′ is acetyl—i.e. the plasticizer is acetyl tris-2-methylbutyl citrate.

In still other embodiments, the plasticizer is as shown in Formula (I) and at least one R group is a branched C₈ alkyl group and R′ is H or acetyl. In some embodiments where one or more R groups are branched C₈ alkyl groups, each of the C₈ alkyl groups is 2-ethylhexyl. In a specific embodiment, all of the R groups are 2-ethylhexyl and R′ is acetyl—i.e., the plasticizer is acetyl tris-2-ethylhexyl citrate.

In still other embodiments, the plasticizer is as shown in Formula (I) and at least one R group is a branched C₈ alkyl groups and R′ is H or acetyl. In some embodiments where one or more R groups are branched C₈ alkyl groups, each of the C₈ alkyl groups is 2-octyl. In a specific embodiment, all of the R groups are 2-octyl and R′ is acetyl—i.e., the plasticizer is acetyl tris-2-octyl citrate.

It will be understood that other specific molecules are encompassed within the scope of Formula (I) and, while not discussed at length herein, are contemplated within the scope of the invention. In fact, various embodiments comprising one or more branched alkyl moieties are encompassed within the scope of the invention. Moreover, in some embodiments, a single plasticizer molecule may incorporate more than one branched alkyl moiety (e.g., a combination of alkyl moieties selected from 2-ethylhexyl, 3-methylbutyl, 2-methylbutyl and 2-octyl). In some embodiments, the plasticizer molecule may incorporate three different alkyl moieties selected from the foregoing group. In still other embodiments, the plasticizer may include two different branched alkyl moieties—i.e., some combination of alkyl moieties that includes two identical moieties, and an additional moiety that is different from the other two, and wherein the moieties are selected from 2-ethylhexyl, 3-methylbutyl, 2-methylbutyl and 2-octyl.

In the various embodiments described herein, the foregoing plasticizer may be present in a PLA composition at a concentration within the range from about 5% to about 35% by weight, within the range from about 7% to about 25% by weight or within the range from about 10% to about 20% by weight.

Citrate plasticizers having a composition as in Formula (I) may be available for purchase from commercial sources such as Jungbunzlauer AG, of Basel, Switzerland. However, plasticizers may also be made according to established synthetic processes which will be understood by those of ordinary skill in the art. For example, plasticizers may be made in a two-step process wherein citric acid is first esterified with an alcohol of choice at 150° C. using a p-toluene sulfonic acid catalyst. The resultant material is acetylated using acetic anhydride at 150° C., again using a p-toluene sulfonic acid catalyst. The resulting plasticizer material is purified and isolated using standard techniques. One or more specific synthetic process(es) can be found in the non-limiting examples herein.

To facilitate crystallization, nucleating agent may also be present in the PLA compositions, typically at a concentration within the range from about 0.1 wt % to about 10 wt %, or within the range from about 0.5 wt % to about 5 wt %. Suitable nucleating agent may be selected by the person of ordinary skill in the art. In some embodiments, suitable nucleating agent(s) may be selected from the group consisting of inorganic minerals, organic compounds, salts of organic acids, finely divided crystalline polymers and combinations of two or more of the foregoing. Examples of useful nucleating agents include, for example, talc (hydrated magnesium silicate —H₂Mg₃(SiO₃)₄ or Mg₃Si₄O₁₀(OH)₂), silica (SiO₂), titania (TiO₂), alumina (Al₂O₃), zinc oxide, sodium salt of saccharin, calcium silicate, sodium benzoate, calcium titanate, boron nitride, copper phthalocyanine, phthalocyanine and the like. Suitable inorganic nucleating agents include those having an average particle size of at least 25 nanometers, or at least 0.1 micron. Combinations of two or more different nucleating agents may also be used.

In preparing a PLA composition according to the invention, the ingredients are thoroughly mixed using any suitable means known by those of ordinary skill in the art. PLA, plasticizer and nucleating agent are mixed to form the PLA composition, and mixing may be accomplished in a mixer (e.g., Brabender mixer), extruder, kneader or the like. Following mixing, the composition may be formed into a film using known techniques, taking in to consideration the scale of the process and available equipment. In some embodiments, the PLA composition is transferred to a press and then compressed and solidified to form individual sheets of PLA film. In other embodiments, the PLA composition may be extruded onto a casting roll maintained at a suitable cooling temperature to form a continuous length of PLA film. Processes for the manufacture of PLA film according to the embodiments of the invention are further described in the non-limiting Examples.

In embodiments of the invention, a PLA film is provided that is partially crystalline and plasticized with a plasticizer having the composition of Formula (I) herein. Such plasticized PLA films show improved properties as compared with PLA films that have been plasticized with other plasticizers. In embodiments wherein the PLA film incorporates a citrate plasticizer, those citrate plasticizers comprising higher molecular weight alkyl moieties typically perform better than those with lower molecular weight alkyl moieties. PLA films that comprise known plasticizers having straight chain alkyl moieties tend to experience a “blooming” phenomenon in which the plasticizer migrates to the surface of the film. Significant blooming of the plasticizer can degrade the physical properties of the film. At elevated temperatures, some citrate plasticizers will evaporate from the surface of the film. As a result, the PLA film may experience a measurable weight loss in addition to the degradation of other physical properties. The presence of branched alkyl moieties of higher molecular weight (e.g., branched C₅ alkyl moieties or larger) provide plasticizers that are typically more stable in PLA films when compared with similar plasticizers having non-branched alkyl-substituents. The branched alkyl-substituted plasticizers used in the various embodiments of the invention show a surprisingly low tendency for “blooming” and thereby contribute to the age-stability of the PLA film. Plasticizers comprising the higher molecular weight branched alkyls generally showed a reduction of the glass transition temperature for the PLA films. In some embodiments, the reduction in the glass transition temperature for the PLA film is in the range from 20° C. to 40° C., and in some embodiments, from about 30° C. to 40° C. In other words, in various embodiments of the invention, the normal glass transition temperature for PLA was reduced from about 60° C. to about 40° C. or less, or to about 30° C. or less, or to about 20° C.

Plasticized polylactide film according to the present invention exhibits good age stability and will not exhibit “blooming” of the plasticizer. In some embodiments, PLA films are provided that include a plasticizer as described in Formula (I) wherein the plasticizer is present at a concentration of about 15% by weight. Because of the use of a plasticizer as described in Formula (I), the PLA film will experience less than about a 3% weight loss when annealed for 4 weeks at a temperature of about 65° C.

In another embodiment, PLA film can incorporate a plasticizer of Formula (I) is present at a concentration of about 15% by weight and the film has less than about a 1% weight loss when annealed for 4 weeks at a temperature of about 65° C.

In various embodiments, the invention provides a process for the manufacture of PLA film having any of a variety of structures on one or both major surfaces thereof, as is described, for example, in commonly owned co-pending U.S. Provisional Application Ser. No. 61/141,120. In specific embodiments, the PLA film is a stemmed web that can be used to make a hook fastener (also referred to as a headed stem mechanical fastener), like those described in, for example, U.S. Pat. Nos. 6,132,660, 6,039,911, 5,679,302, and 6,635,212. In other embodiments, a matte-finished film may be provided. The structures of an exemplary matte-finished film structured surface can have a Roughness average (Ra) of at least about 1.25 microns.

In other embodiments, the molten PLA composition can be formulated to contain PLA and optionally other polymers compatible with PLA. Typically, the polylactide includes less than 5 wt-% d-lactide, or less than 2 wt-% d-lactide.

PLA films made according to an embodiment of the present invention can be used in a variety of products. For example, they can be used as hook and loop fasteners in the closure mechanism on disposable garments, such as diapers or hospital gowns, as the backsheet of a diaper, in tape (such as diaper tape), tape flags, lint removal tapes (e.g., in lint rollers), and in laminates of the films to other substrates such as nonwovens and paper. For example, a matte-finished PLA-containing film can be used in diapers (e.g., as the backsheet or tape backing), tapes, tape flags, and home care applications such as lint removal tapes. The matte-finished surface can be on one side of a matte-finished PLA film or on both sides if desired. The adhesive in a tape that uses a matte-finished film of the present invention as a backing can be disposed on the matte-finished surface or on the opposite (typically, smooth) surface.

In place of a hook and loop fastener system, such disposable garments can include adhesive fastening tabs (e.g., diaper tapes). Such tapes can include a PLA film, such as a matte-finished film, comprising a surface having a layer of adhesive thereon. Other tapes can be made using a PLA film backing made in accordance with the present invention and suitable for use in a wide variety of other applications, such as tape flags or the tape used in a lint removal sheets or rollers. A wide variety of adhesives can be used such as a tackified elastomer (e.g., an A-B type block copolymer).

In further describing the embodiments of the invention, a first composition is provided that includes polylactide resin and plasticizer of the formula:

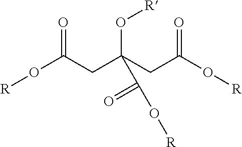

wherein
R may be the same or different and wherein at least one R groups is a branched alkyl group having a carbon chain length of C₅ or greater; and
R′ is an H or an acyl group.

A second composition is provided that can be a version of the first composition having any or all of the previously described features and wherein R is one or more branched alkyl groups having a carbon chain length of C₅ to C₁₀.

A third composition is provide that can be a version of the first or second compositions. In the third composition, R is one or more branched alkyl groups having a carbon chain length of C₅ to C_{g}.

A fourth composition is provided that can be a version of any of the first to third compositions. In the fourth composition, plasticizer is present in the composition at a concentration within the range from about 5% by weight to about 35% by weight.

A fifth composition is provided that can be a version of any of the first to fourth compositions. In the fifth composition, the composition further includes nucleating agent in an amount between about 0.1 wt % and about 10 wt %. The nucleating agent is selected from the group consisting of inorganic minerals, organic compounds, salts of organic acids, and finely divided crystalline polymers.

A sixth composition is provided that can be a version of any of the first to fifth compositions. In the sixth composition R′ is H or acetyl and at least one R group is a branched C₅ alkyl group.

A seventh composition is provided that can be a version of any of the first to sixth compositions. In the seventh composition R′ is H or acetyl and at least one R group is 3-methylbutyl or 2-methylbutyl.

An eighth composition is provided that can be a version of any of the first to seventh compositions. In the eighth composition all the R groups are 3-methylbutyl or 2-methylbutyl.

A ninth composition is provided that can be a version of any of the first to fifth compositions. In the ninth composition R′ is H or acetyl and at least one R group is a branched C₈ alkyl group.

A tenth composition is provided that can be a version of the ninth composition. In the tenth composition R′ is H or acetyl and at least one R group is 2-ethylhexyl.

An eleventh composition is provided that can be a version of the ninth or tenth compositions. In the eleventh composition, all three R groups are 2-ethylhexyl.

A twelfth composition is provided that can be a version of the ninth composition. In the twelfth composition, R′ is H or acetyl and at least one R groups is 2-octyl.

An thirteenth composition is provided that can be a version of the ninth or twelfth compositions. In the thirteenth composition, all three R groups are 2-octyl.

In addition to the foregoing compositions, a first PLA film is provided. The first film is made from any of the first to thirteenth compositions and wherein the film is at least partially crystalline.

A second PLA film is provided that can be version of the first film. The second film includes plasticizer in the film at a concentration from about 5% by weight to about 35% by weight.

A third film is provided that can be a version of the first or second films. The third film has a glass transition temperature less than about 50° C.

A fourth film is provided that can be a version of the first to third films. The fourth film has a plasticizer present at a concentration of about 15% by weight and the film experiences less than about a 3% weight loss when annealed for 4 weeks at a temperature of about 65° C.

A fifth film is provided that can be a version of the first to fourth films. The fifth film feature has a plasticizer present at a concentration of about 15% by weight and the film experiences less than about a 1% weight loss when annealed for 4 weeks at a temperature of about 65° C.

In addition to the compositions and films, a first process is providing for making a semicrystalline polylactide film, including the steps of:

(a) Providing a polylactide composition as comprising:
(i) Polylactide resin,
(ii) Nucleating agent, and
(iii) Plasticizer of the formula

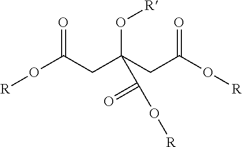

wherein
   R may be the same or different and wherein at least one R group is a branched alkyl having a carbon chain length of C₅ or greater, and
   R′ is H or an acyl group; and
(b) Extruding the composition as a molten sheet; and
(c) Cooling the sheet to crystallize the polylactide and provide the film.

A second process is provided that can have all of the features of the first process. In the second process, plasticizer is present in the composition at a concentration from about 5% by weight to about 35% by weight.

A third process is provided that can have all of the features of the first or second processes. The third process adds a nucleating agent to the composition in an amount of between about 0.1 wt % and about 10 wt %. The nucleating agent is selected from the group that includes inorganic minerals, organic compounds, salts of organic acids, and finely divided crystalline polymers.

A fourth process is provided that can have all of the features of the first to third processes. The fourth process utilizes plasticizer where the R′ group is H or acetyl and at least one R group is a C₅ branched alkyl group.

A fifth process is provided that can have all of the features of the fourth process. The fifth process utilizes plasticizer where the R′ group is H or acetyl and at least one R group is 3-methylbutyl.

A sixth process is provided that can have all of the features of the fourth or fifth processes. The sixth process utilizes plasticizer where R′ is H or acetyl and all R groups are 3-methylbutyl.

A seventh process is provided that can have all of the features of the fourth process. The seventh process utilizes plasticizer where the R′ group is H or acetyl and at least one R group is 2-methylbutyl.

An eighth process is provided that can have all of the features of the seventh process. The eighth process utilizes plasticizer where R′ is H or acetyl and all R groups are 2-methylbutyl.

A ninth process is provided that can have all of the features of the first to the third processes. The ninth process utilizes plasticizer where R′ is H or acetyl and at least one R group is a C₈ branched alkyl group.

A tenth process is provided that can have all the features of the ninth process, but where the plasticizer includes an R′ that is H or acetyl and at least one R groups are 2-ethylhexyl.

An eleventh process is provided that can have all of the features of the ninth or tenth processes, but wherein R′ is H or acetyl and all R groups are 2-ethylhexyl.

A twelfth process is provided that can have all of the features of the first to third processes, but wherein R′ is H or acetyl and at least one R group is 2-octyl.

A thirteenth process is provided that can have all of the features of the twelfth process, but wherein R′ is H or acetyl and all R groups are 2-octyl.

A fourteenth process is provided that can have all of the features of the first to thirteenth processes, but wherein the composition is extruded onto a tool roll having structured surface.

A semicrystalline polylactide film is provided made according to any of the first to fourteenth processes.

A polylactide article is provided in the form of a disposable garment made according to any of the first to fourteenth processes. The disposable garment can be a diaper.

Additional embodiments are also described in the following non-limiting examples.

### EXAMPLES

The following Examples are set forth to describe additional features and embodiments of the invention. All parts are by weight unless otherwise indicated.

### Materials:

PLA—polylactic acid having the commercial designation “4032D” obtained from Natureworks LLC, Minnetonka, Minn.

C4 plasticizer—is acetyl tri(n-butyl) citrate plasticizer commercially obtained under the trade designation “Citroflex A4” from Vertellus Performance Materials, Greensboro, N.C.

C8 plasticizer—is acetyl tris-2-ethylhexyl citrate plasticizer obtained under commercially under the trade designation “Citrofol AHII” from Jungbunzlauer, Basel, Switzerland.

C5 plasticizer—is acetyl tri(methyl butyl) citrate plasticizer made according to the general procedure below.

### Preparation of Other Plasticizers:

Citric acid monohydrate and 3 equivalents of alcohol were added to a 3-neck round bottom flask and dissolved in toluene (˜0.5 g reactant/mL toluene). A small amount of acid catalyst (p-toluenesulfonic acid, 1 wt % of citric acid) was added, and the flask was stirred and heated to 150° C. under a nitrogen atmosphere. The product of the reaction, water, and toluene were volatilized at their azeotrope, 85° C. A condenser with a Dean-Stark trap was used to collect the volatilized solvents, and the denser water phase was drained occasionally. Removing water from the flask helped drive the reaction to completion. After 6-24 hrs reaction, the solution was cooled to room temperature. The trialkyl citrate product was purified and isolated by washing with sodium bicarbonate solution, deionized water rinse, brine rinse, stirred over magnesium sulfate, filtered, and any remaining liquids were removed in a rotary evaporator.

The isolated trialkyl citrate product was added to a round bottom flask with acetic anhydride (1.5 equivalents). The contents were dissolved in toluene to a concentration of ˜0.4 g reactant/mL toluene. A small amount of acid catalyst, such as p-toluenesulfonic acid, was added (1 wt % of citrate), and the flask was stirred and heated to 80° C. under a nitrogen atmosphere. After 6-24 hrs reaction, the solution was stirred over ice for ˜45 min to hydrolyze the excess acetic anhydride. The acetyl trialkyl citrate product was purified and isolated by washing with sodium bicarbonate solution, deionized water rinse, brine rinse, stirred over magnesium sulfate, filtered, and any remaining liquids were removed in a rotary evaporator.

### Test Methods

### DSC (Differential Scanning Calorimetry)

The crystallinity and glass transition temperature of the plasticized film samples were measured using a TA Instruments Q2000 Differential Scanning calorimeter. Each ˜10 mg sample was heated from 0° C. to 220° C. at 10° C./min, and the representative initial crystalline enthalpy was taken as the difference between the cold crystallization and melting enthalpies. Degree of crystallinity was determined using 100 J/g for the case of 100% crystalline PLA. Typically, maximum PLA crystallinity is about 35%.

### Tear Strength

Tear testing was conducted using a Protear Elmendorf Tear Tester (Twing-Albert Instrument Co.) with a 1600 g weight. Tensile testing was performed using an Instron Model 1122, 5500R. Each 2.5-cm wide, 63.5 micron thick film strip was stretched from a 5-cm starting length at 25.4 cm/minute.

### Tensile Strength and Modulus

Tensile testing was performed using an Instron Model 1122, 5500R. A sample width of 2.5 cm was used with a gauge length of 5 cm. A crosshead speed of 25.4 cm/minute was used to stretch the samples.

### Example 1

A plasticized semi-crystalline polylactic acid film was prepared using a polylactic acid (PLA) polymer (4032D obtained from Natureworks LLC, Minnetonka, Minn.) and the following procedure. A 40-mm 10-zone twin screw extruder (40:1 L/D) was used to melt and extrude the PLA polymer, plasticizer, and nucleating agent to a positive displacement metering pump and then into a 25-centimeter (25-cm) wide conventional coat-hanger film die. The PLA polymer was dried for a minimum of 12 hours at 60° C. to remove any moisture and then fed to the first zone of the extruder using a loss-in-weight feeder at a feed rate of 7.7 kilograms per hour (kg/hr). The first zone was water-cooled at approximately 25° C. The second zone of the extruder was set at 210° C. while the remaining eight zones were set at 180° C. The die temperature was maintained at 180° C. The extruder speed was set at 200 revolutions per minute (RPM). A nucleating agent (UltraTalc 609) was fed into the first extruder zone using a loss-in-weight feeder to achieve a 2.5% by weight concentration based on the final film. An acetyl tri(methyl butyl) citrate plasticizer (C5) was fed into zone 3 of the extruder using a calibrated volumetric pump to achieve a 15% by weight concentration based on the final film composition. The extrudate from the extruder was deposited vertically downward into a nip consisting of a 48-cm diameter temperature-controlled matte finish treated steel tool roll (105° C.) on one side and a 20-cm diameter chill (cooling) roll on the opposite side. A nip force of 116 N per lineal cm was used.

A continuous silicone rubber belt was wrapped around the cooling roll (approximately 180 degrees of wrap) to aid in the extrusion process. The inner surface (the surface not in contact with the extrudate) of the belt was cooled with two steel rolls at a setpoint of 20° C. The extrudate remained in contact with the belt and tool roll for approximately 180 degrees of the tool roll circumference measured from the point of initial extrudate deposition. The cooled extruded film was then separated from the belt, and remained in contact with the tool roll for an additional approximate 60 degrees of wrap before being wound into a continuous roll. The film was pulled from the tool roll at 9.1 meters/minute (m/min) using a driven peel-off rubber coated roll that was run slightly faster relative to the speed of the tool roll. The tool roll was prepared by sandblasting a chrome-plated steel roll to achieve an average Ra roughness of 5.9 microns. Film windup speed was adjusted to achieve a film thickness of approximately 65 microns.

### Example 2

A plasticized polylactic acid film was prepared as in Example 1 except the concentration of the plasticizer was increased to 20% by weight.

### Example 3

A plasticized polylactic acid film was prepared as in Example 1 except Citrofol AHII was used as the plasticizer at a concentration of 15% by weight.

### Comparative Example C1

A plasticized polylactic acid film was prepared as in Example 1 except that Citroflex A4 was used as the plasticizer at a concentration of 15% by weight.

### Comparative Example C2

A plasticized polylactic acid film was prepared as in Comparative Example C1 except that the A4 plasticizer was used at a concentration of 20% by weight.

### Control Film

A polylactic acid film was prepared as in Example 1 except that no plasticizer or nucleator was used.

Five replicates of samples from Examples 1-3, Comparative Examples C1 and C2 and the Control were tested with the averages reported in Table 1 below. Tensile stress at break, strain at break and Young's modulus were recorded for each.

TABLE 1

| | | Crystal- | Tear | Tensile | Elongation | |
|---|---|---|---|---|---|---|
| | Tg | linity | Strength | Strength | at Break | Modulus |
| Example | (° C.) | (wt-%) | (grams) | (MPa) | (%) | (MPa) |
| 1 | 32.6 | 1.4 | 76 | 33.7 | 22 | 2000 |
| 2 | 27.7 | 6.4 | 163 | 22.8 | 137 | 1400 |
| 3 | 47.0 | 7.3 | 51 | 34.6 | 37 | 2340 |
| C1 | 28.3 | 16.3 | 88 | 29.3 | 94 | 1160 |
| C2 | 20.7 | 22.5 | 127 | — | — | — |
| Control | 60 | 0 | 15 | 28.6 | 2 | 3070 |

### Examples 4-9, Comparative Examples C3-05

Samples were prepared by mixing PLA with plasticizer (15 wt %) in a Brabender batch mixer at 75 rpm, 180° C. for 5 minutes. The five minute mixing time was sufficient to disperse the plasticizer uniformly within the PLA resin. The composition was transferred to a press, and compressed to form 5 mil thick sheets. Age stability of each plasticizer in PLA was assessed by measuring the weight of the PLA sheets over time as they were exposed to elevated temperatures (65° C.). Temperatures were maintained using convection ovens. Data is presented in Table 2 as fractional weight loss over a four week time period. The cause of the weight loss for each sample was investigated using ¹H NMR and was found to be caused by plasticizer evaporation, and not from degradation of PLA. Table 2 includes an additional observation to note whether the surface of the aged sheet was “oily” due to plasticizer collected on the surface of the sheet—indicated in Table 2 by a “+”.

TABLE 2

| | | % Weight Loss | |
|---|---|---|---|
| Example | Plasticizer | (4 wks, 65 C.) | Oily |
| Control | none | 0.9 | − |
| C3 | Citroflex A4 | 5.4 | − |
| C4 | Acetyl Tripentyl Citrate | 2.1 | + |
| C5 | Acetyl Trihexyl Citrate | 1.6 | + |
| 4 | Acetyl Tri(3-methylbutyl) Citrate | 3.0 | − |
| 5 | Citrofol AHII | 0.4 | − |
| 6 | Acetyl Tri(2-octyl) Citrate | 0.3 | − |
| 7 | Acetyl tri(3-methylbutyl:butyl) (1:2) | 3.3 | − |
| | Citrate | | |
| 8 | Acetyl tri(2-ethylhexyl:butyl) (1:2) | 1.7 | − |
| | Citrate | | |
| 9 | Acetyl tri(2-octyl:butyl) (1:2) Citrate | 1.8 | − |

Various embodiments of the invention have now been described in sufficient detail for those of ordinary skill in the art to understand. While the embodiments have been fully disclosed, it will be appreciated that changes or modifications to the described embodiments may be made without departing from the true spirit and scope of the invention, as set forth in the appended claims.

1. A composition comprising:
polylactide resin; and
plasticizer of the formula 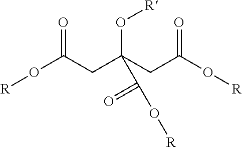
wherein
R may be the same or different and wherein at least one R is a branched alkyl group having a carbon chain length of C₅ or greater; and
R′ is an H or an acyl group.

2. The composition according to claim 1 wherein R is one or more branched alkyl groups having a carbon chain length of C₅ to C₁₀.

3. (canceled)

4. The composition of according to claim 1 wherein plasticizer is present at a concentration within the range from about 5% by weight to about 35% by weight.

5. The composition according to claim 1 further comprising nucleating agent in an amount of between about 0.1 wt % and about 10 wt % and wherein the nucleating agent is selected from the group consisting of inorganic minerals, organic compounds, salts of organic acids, and finely divided crystalline polymers.

6. The composition according to claim 1 wherein R′ is acetyl and at least one R group is a branched C₅ alkyl group.

7-8. (canceled)

9. The composition according to claim 1 wherein R′ is H or acetyl and at least one R group is a branched C₈ alkyl group.

10-13. (canceled)

14. A polylactide film made with the composition of claim 1 wherein the film is at least partially crystalline.

15. The polylactide film of any of claim 14 wherein the plasticizer is present in the film at a concentration in the range from about 5% by weight to about 35% by weight.

16. The polylactide film of claim 14 having a glass transition temperature of less than about 50° C.

17. The polylactide film of claim 14 wherein the plasticizer is present at a concentration of about 15% by weight and the film has less than about a 3% weight loss when annealed for 4 weeks at a temperature of about 65° C.

18. The polylactide film of claim 14 wherein the plasticizer is present at a concentration of about 15% by weight and the film has less than about a 1% weight loss when annealed for 4 weeks at a temperature of about 65° C.

19. A process for providing an semicrystalline polylactide film, comprising:
(a) providing a polylactide composition as comprising:
(i) polylactide resin,
(ii) nucleating agent, and
(iii) plasticizer of the formula 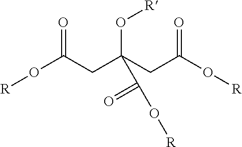
wherein
R may be the same or different and wherein at least one R group is a branched alkyl groups having a carbon chain length of C₅ or greater, and
R′ is H or an acyl group; and
(b) extruding the composition as a molten sheet; and
(c) cooling the sheet to crystallize the polylactide and provide the film.

20. The process of claim 19 wherein the plasticizer is present in the composition at a concentration in the range from about 5% by weight to about 35% by weight.

21. The process according to claim 19 wherein the nucleating agent is added to the composition in an amount of between about 0.1 wt % and about 10 wt %, the nucleating agent being selected from the group consisting of inorganic minerals, organic compounds, salts of organic acids, and finely divided crystalline polymers.

22. The process according to claim 19 wherein R′ is H or acetyl and at least one R group is a C₅ branched alkyl group.

23-26. (canceled)

27. The process according to claim 19 wherein R′ is H or acetyl and at least one R group is a C₈ branched alkyl group.

28-31. (canceled)

32. The process according to claim 19 wherein the composition is extruded onto a tool roll having structured surface.

33-36. (canceled)
